(19) United States
(12) Patent Application Publication
(10) Pub. No.: US 2024/0100703 A1
(43) Pub. Date: Mar. 28, 2024

(54) DEVICE FOR HANDLING PRODUCTS IN CONTAINERS BASED ON MOVEMENT BY ELASTIC PRESSURE ON THE TOP OF THE CONTAINERS

(71) Applicant: MAQUINAS SANMARTIN LTDA, Caxais do Sul (BR)

(72) Inventor: Jose Bernardo SANMARTIN, BARRIO CIDADE NOVA (BR)

(21) Appl. No.: 18/276,048

(22) PCT Filed: Feb. 17, 2021
(86) PCT No.: PCT/BR2021/050071

§ 371 Date: Aug. 7, 2023

(30) Foreign Application Priority Data
Feb. 9, 2021 (BR) 20 2021 0024165

(51) Int. Cl. B25J 9/16; B25J 13/08; B65G 61/00

(52) U.S. Cl. CPC B25J 9/1687; B25J 13/082; B65G 61/00; B65G 2201/0235

(57) ABSTRACT

The present utility model refers to a device coupled to a robot or another moving system, exerting elastic pressure on the upper part over can containers, allowing to keep the products to be moved as fixed, displacing and turning them, defining their positions and organizing them for later palletization, enhanced with the introduction of locking pins, side wings, a lower metal plate covered by an elastic polymer with an innovative checkerboard design and a compression spring system, in the field of application intended to the industry and distribution centres for beverage and food, in the area of preparation of product container layers, ready before palletization.

This utility model refers to a device coupled to a robot or other moving system, putting elastic pressure over the top of the can containers, allowing to keep the products to be moved as fixed, displacing and turning them, defining their position and organizing them for future palletization, enhanced with the introduction of locking pins, side wings, a lower metal plate covered by an elastic polymer with innovative checkerboard design and a compression spring system, in the field of application of the industry and distribution centers for beverages and foods, in the area of preparation of ready product container layers before palletization.

In the current state of the art by the traditional system to form flexible layers, using robots or other moving devices, there is a limitation in the quantity of cycles per minute per tweezers. To increase system production, alternative feeding systems are added, generating hardware changes in the package feeding system, including of tweezers of various sizes, especially allowing to move more than one package per operation, generating an eventual production discontinuity, increase in the operation area and higher energy consumption.

The U.S. Pat. No. 9,771,220B1 has an activation system located below the transport conveyor, operating by means of a PLC, guiding the rollers and the packages in the desired orientation. That system has an inconvenience, since the whole activation system is positioned below the transport conveyor, causing instability when handling smaller packages due to the activation system by rollers with other difficulties caused by the lack of precision in the position of packages when moved and reduced flexibility, particularly due to a limitation in the quantity of possible movement operations, caused by the mechanical hardware of the system.

From the same owner or applicant, the state of the art includes the patent of invention BR 102019012951-4, comprising a DEVICE FOR HANDLING PRODUCTS IN CONTAINERS, SOLELY OR IN GROUPS, BASED ON THE MOVEMENT BY ELASTIC PRESSURE ON THE TOP OF THE CONTAINERS, referring to a device coupled to a robot or another movement system, putting pressure over the container, allowing to hold the products to be moved, displacing and turning them, defining their position and organizing them for later palletization or positioning the subsequent ones, wherein that device is formed by a metal head, a base set, constituted, in its lower part, by a set constituted by a lower metal plate and covered with an elastic polymer attached to the upper plate of the device by means of a spring system or other elastic element with memory, said system comprising bolts with washers, the lower metal plate and the upper plate being joined in four spots with holes next to the vertices of the upper plate, with coincident attaching points to the base set, and the upper plate having a central hole and flanges. That system showed a few difficulties with stronger friction between the claw and the containers, which may cause premature wearing of the parts, and consequent breaks in the handled products; pin clamping; wear or slack between the upper plate and the lower sleeves; and wear or slack in the attaching spots on the flanges, caused by the system with holes joining them to the upper plate.

An object of this utility model patent application is a device (1) for handling products in containers (C1), based on the movement by elastic pressure on the top of the containers (C1), being the distribution made by said arrangers operating in different axes, under the command of dedicated software for each application and moved by a robot (R1), allowing for the arrangement of can containers, wherein said device and the respective software are adapted for the various types and measurements of containers (C1), solely or in groups, and, within the logics of each program, creates the organization of the configuration of the moved containers for subsequent operations, including the formation of layers for palletization (C2).

In this enhancement or utility model to be disclosed, the device is constituted by a metal structure, a compression spring system (5) with memory to be coupled to the flange of a robot, a set formed by a metal structure and an elastic polymer cover is coupled to the lower part of the device, so to keep the integrity of the containers and allow their movement, wherein, due to the pressure system and the introduction of two side wings (17) on its edges, that lower part of the device set may be smaller than the measurements of the container to be handled.

The device has an adequate coupling for each kind of robot, counting on the tool exchange solution, which is performed automatically, with devices in standby, strategically located in the working area for cases when the products are changed for handling or in case of change of the device.

The device (1) is operated above a flat working area (2) allowing the containers (C1) to enter through their respective conveyors, wherein, when entering the flat working area (2), the containers (C1) are identified by software in a previously established order and adequately moved to the desired formation.

The movement is made by the robot (R1), locating the device (1) over the container (C1) by means of controlled elastic pressure to avoid damage to the container (C1), dragging it lengthwise (L1), crosswise (T1) and rotating (G1) (clockwise and anti-clockwise) over the flat working area (2), positioning the container (C1) in the exact location according to the scheduled arrangement.

By the monitoring routine of the device (1) as included in the software, the system identifies if the device must be substituted when the elastic polymer (3) is reaching the end of its working life, and automatically performs the operation in a device magazine (4) inserted besides the flat working area (2), so to uncouple the worn or damaged device (1) and couple another full device (1), re-starting the operation within seconds, thus avoiding long interruptions. The same procedure may be used in case a setup change in the container (C1) is planned.

An essential feature refers to data standardization to operate the device, which is required to guarantee the attack pressure of the device and the tension of the compression spring system (5) or other elastic system in the container (C1). In both cases, said definition is empirically made, for each kind of product to be handled.

The parameters of the compression spring system (5) are defined, considering the measurements and quality of said elastic system, i. e. higher or lower tension of the material.

The attack pressure of the device (1) is also empirically defined, defining as a base the height of the container (C1) to be operated, and additional advancement gradients on the height of the device. Performance evaluations are made for each configuration and defined by the better performance in positioning precision and device speed (1), always maintaining the integrity of the set.

The device (1) is formed by a metal head (6) or made of another material which may be formed within the appropriate measurements and characteristics (weight and strength), being configured by a base set (7) and a flange (9), for engaging the movement device or robot (R1).

In the lower part of the base set (7) of the device (1), a set constituted by a lower metal plate (8) and covered with an elastic polymer (3) is assembled, having its design changed into a checkerboard shape, so to guarantee more efficient friction between the claw and the container (C1), wherein the base set (7) is fixed to the upper plate (6) of the device (1), by means of a spring system (5), said system comprising bolts (11) and pins, besides the essential constituents joining the lower metal plate (8) to the upper plate (6).

The connection as disclosed above is performed in four spots with holes (12), next to the vertices of the upper plate (10), with coincident fixing spots with the base set (7), being attached to the upper plate (10) by innovative locking pins (13) for said flange (9).

The connection is performed by means of the lower sleeve (14) receiving the spring (5), involving the guide pin (15), projecting from the sleeve (16) which is coupled to the upper plate (10). In between the plate (7) and the lower sleeves (14), side wings (17) are assembled. The course of the system was increased, so to improve the flexibility of the system and the pin (15) was relieved in its diameter, so to avoid being locked during the operation, consequently also increasing the protection ability of the robot under excessive torque.

In the central part of the upper plate (10), there are locking pins (13) receiving the lock set constituted by the flange (9) used for engagement to the mouth of the robot (R1).

The devices used for the connection between the base set (7) and the upper plate (6) have the purpose to regulate and maintain the pressure of the elastic polymer (3), providing the appropriate pressure to keep the set as attached to the device (1), however allowing for the necessary movement over the flat working area (2).

The device (1) has innovative side wings (17) helping to drag the container (C1), reducing the friction coefficient over the conveyor.

The main advantage offered by this enhancement refers to the increase in moving speed, since the present device allows to perform up to one hundred fifty (150) movements per minute, so to reach considerable increase in the number of cycles/minute, with high reliability. Therefore, it is possible to reduce the full investment over conventional devices, for the same production ability, besides lower space occupation (about 50% of the area as required by the traditional systems), thus substantially reducing electricity consumption as involved in the operation.

Another characteristic involved in the present utility model refers to the automatic latch system of the device, particularly indicated in shape change situations (quick setup), by which the operation suffers minimal interruptions, with a quick re-start, improving the efficiency of the operation, besides reducing the stop time of the device provided by the automatic change of an eventually broken device or for the wear and tear of said device during the operation.

Another important advantage obtained with the new device is the reduction of the setup time, assured as a function of the size of the lower part of the device set being smaller than the measurements of the container to be handled. Therefore, there is no need to partially involve the container around its perimeter when handled, since the side wings (17) introduced between the plate (7) and the lower sleeves (14), helping to drag the containers with different sizes, minimizing the need of setup during the changes of shapes of the containers and reducing the friction coefficient over the conveyor.

Furthermore, there is less need of maintenance, in comparison with conventional systems, as a function of the lower friction as provided by the change of the innovative checkerboard design, covered with an elastic polymer (3), reducing the contact between the base (7) and the lower metal plate (8) of the lower part set.

In the lower part of the base in this enhancement, locking pins (13) were included, substituting the holes, so to attach the flange (9), thus improving the junction.

For better understanding of the present utility model, it will be disclosed in figures as follows:

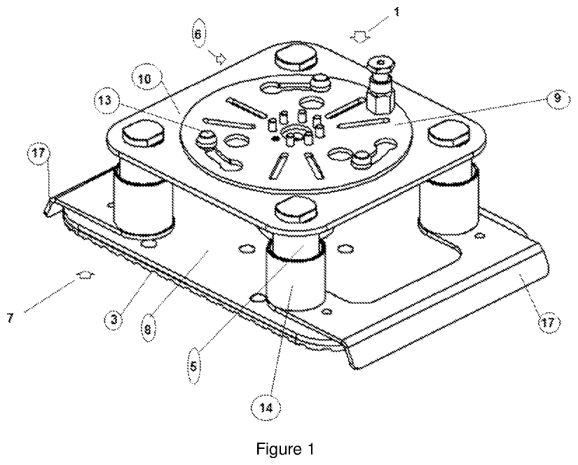

FIG. 1: perspective view of the device;

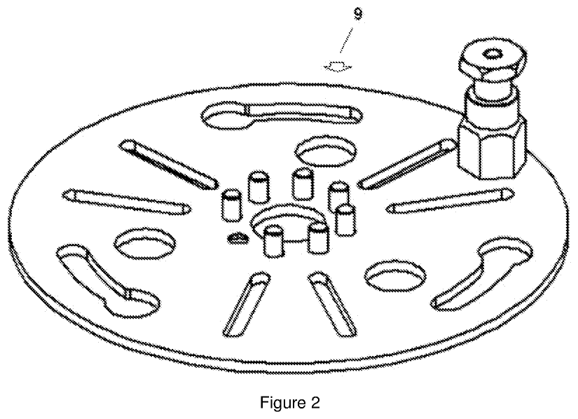

FIG. 2: perspective view of the upper flange;

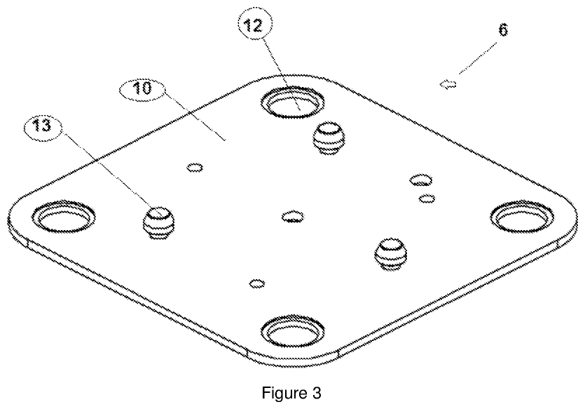

FIG. 3: perspective view of the upper plate;

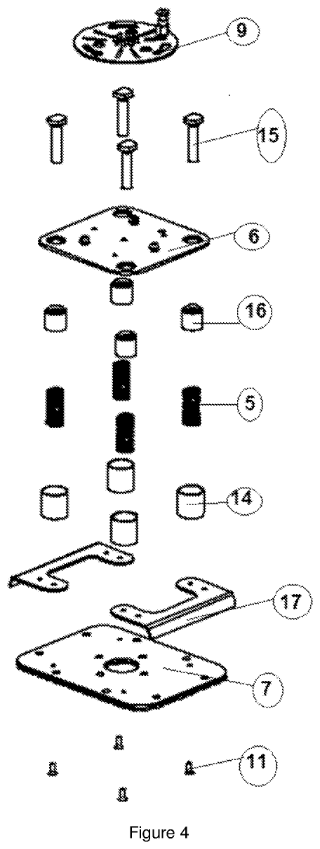

FIG. 4: exploded perspective view;

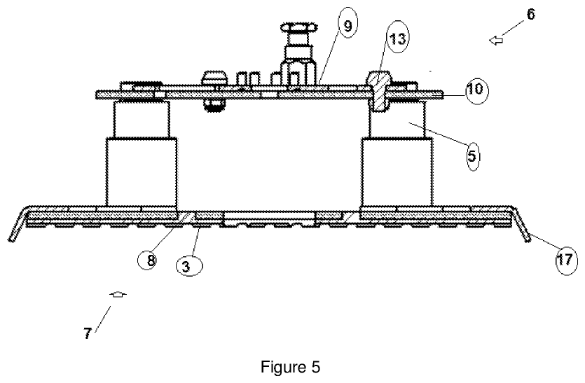

FIG. 5: side view of the device;

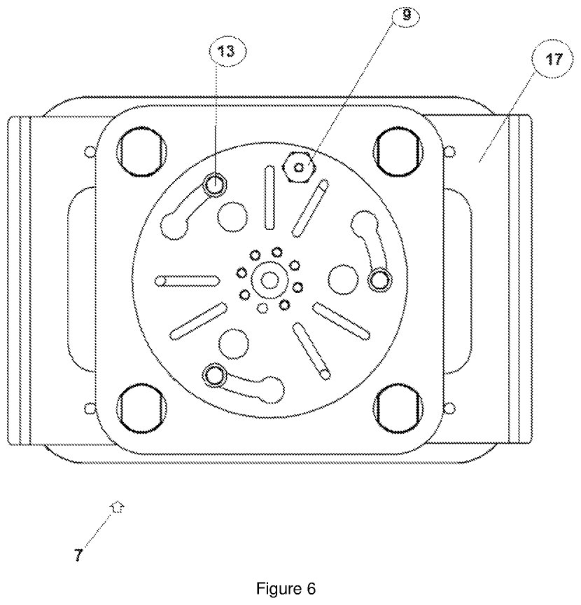

FIG. 6: upper view of the device;

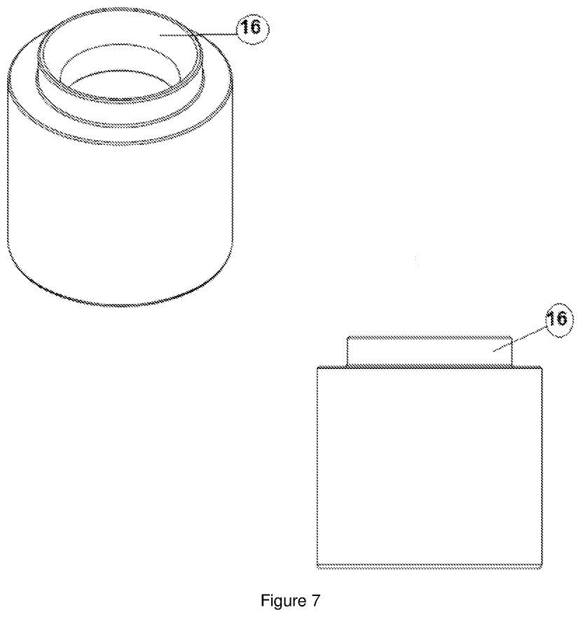

FIG. 7: perspective and side views of the sleeve;

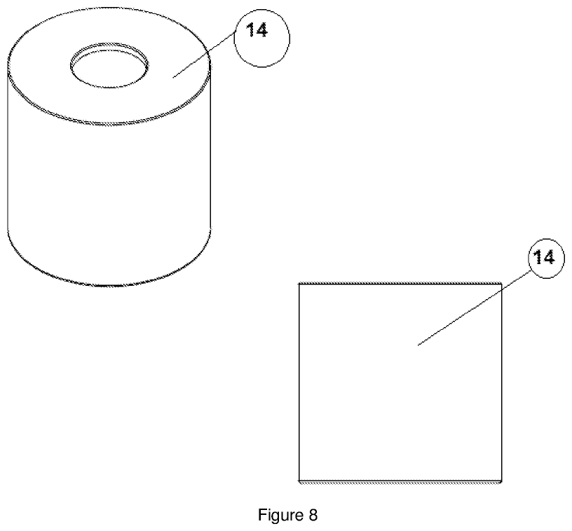

FIG. 8: perspective and side views of the lower sleeve;

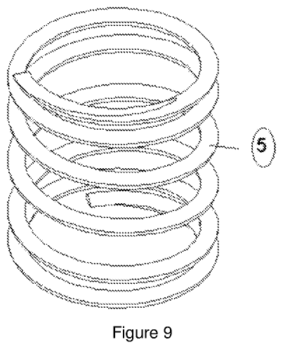

FIG. 9: perspective view of the compression spring;

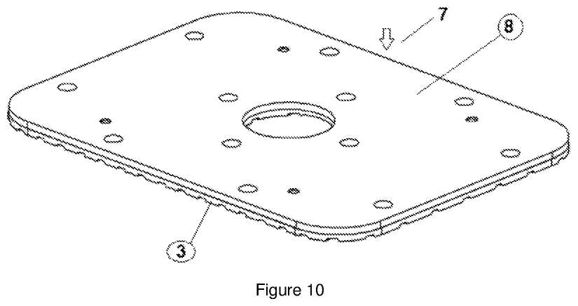

FIG. 10: perspective view of the base plate;

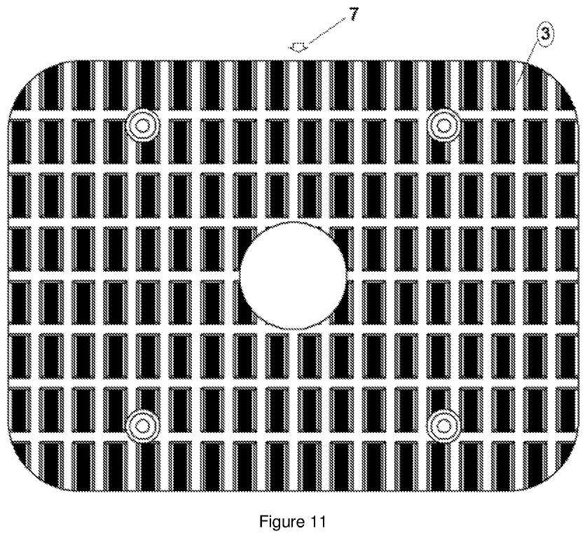

FIG. 11: upper view of the base plate;

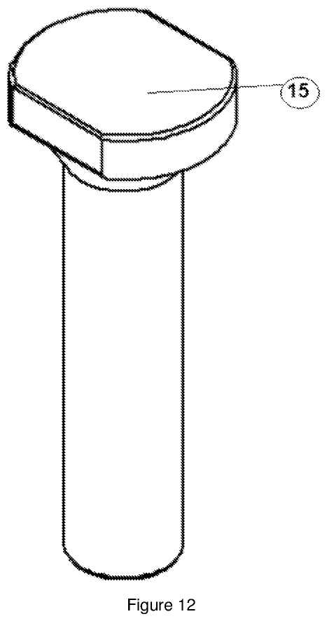

FIG. 12: upper view of the guide pin;

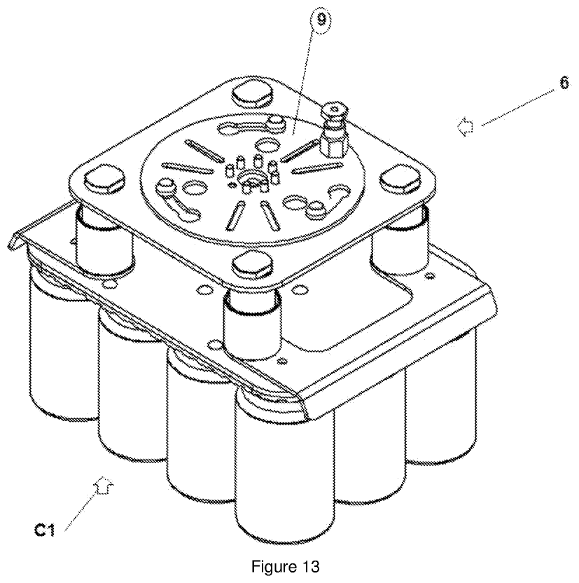

FIG. 13: perspective view of the device coupled to a can container;

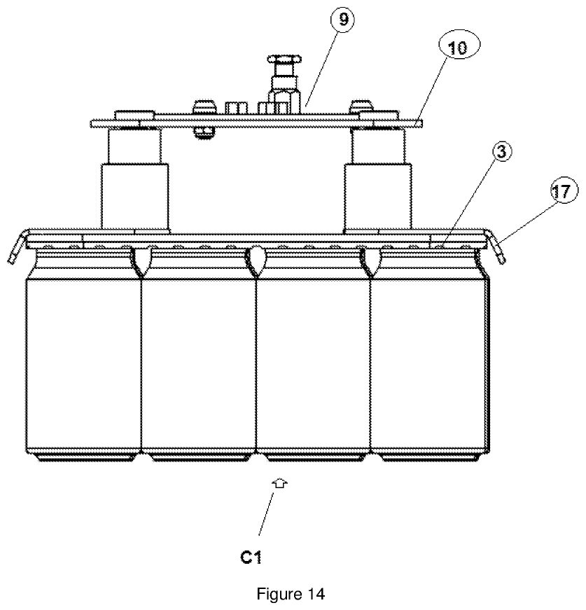

FIG. 14: side view of the device coupled to a can container;

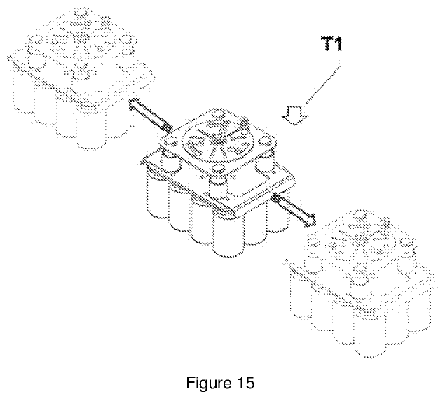

FIG. 15: perspective view showing the crosswise movement of the device while in use;

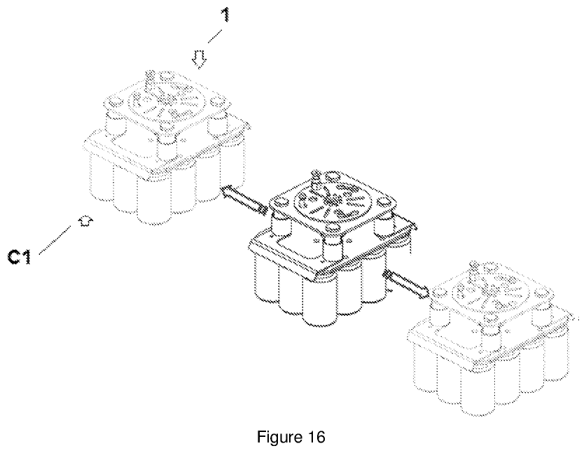

FIG. 16: perspective view showing the lengthwise movement of the device while in use;

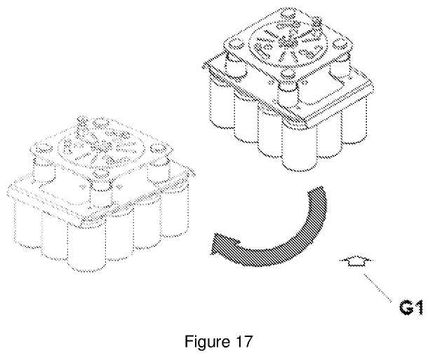

FIG. 17: perspective view showing the rotating movement of the device clockwise;

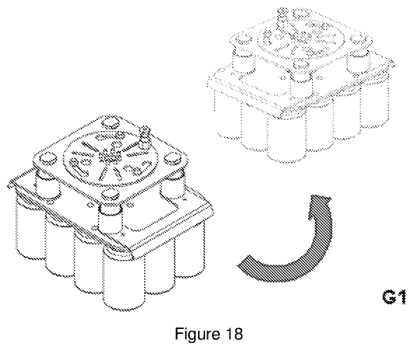

FIG. 18: perspective view showing the rotating movement of the device anti-clockwise;

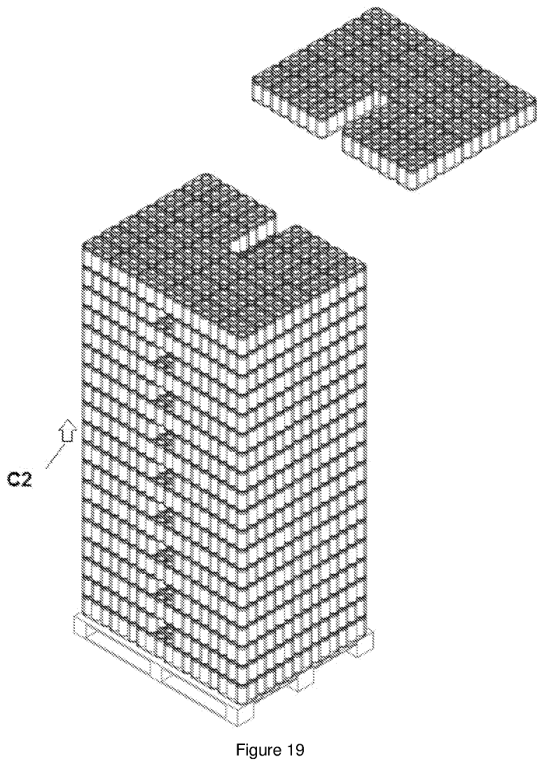

FIG. 19: perspective view of a mosaic formed by containers assembled over a pallet;

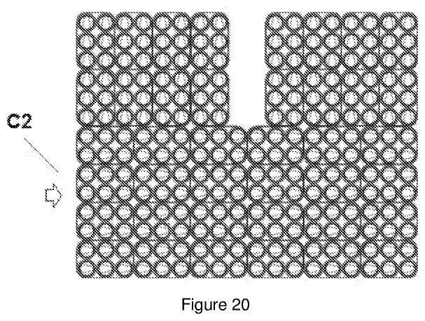

FIG. 20: upper view of the mosaic;

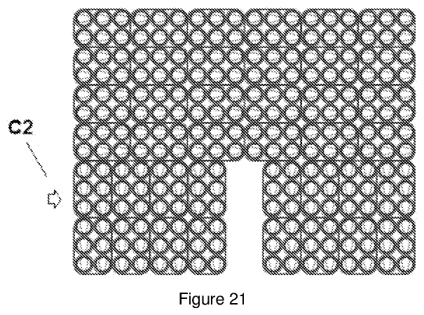

FIG. 21: mirrored upper view of the mosaic of the previous figure;

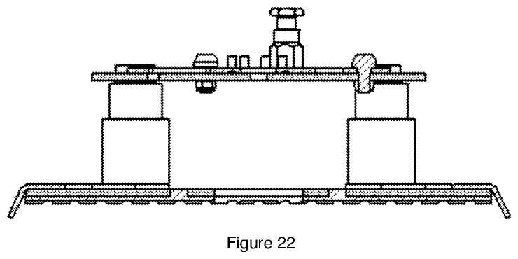

FIG. 22: front view of the device;

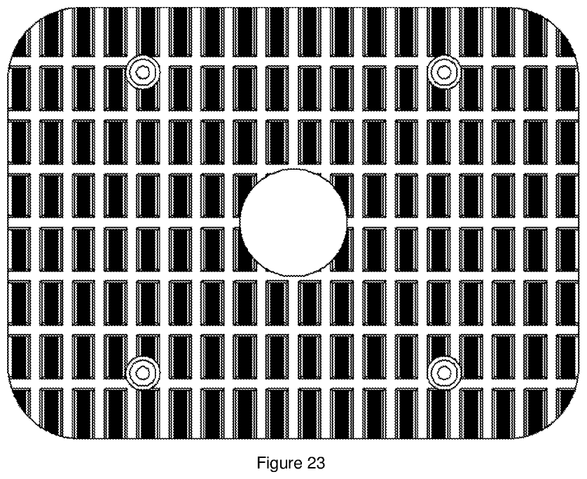

FIG. 23: lower view of the device; and

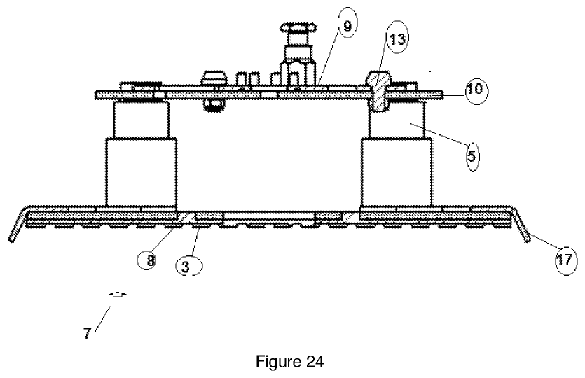

FIG. 24: back view of the device.

1-10. (canceled)

11. A method for handling products in containers (C1) based on controlling movement of the containers by the use of elastic pressure on the top of the containers, wherein the method is adapted to organize said containers in groups and move said groups in preparation for subsequent operations, including the formation of palletization layers (C2), the method comprising
(i) providing a device for handling products in containers comprising a metal frame having an upper part and a lower part, attached to a compression spring system (5) coupled to a flange of a robot, and two side wings (17) attached to the edges of the frame, and an elastic polymer cover coupled to the lower part of the device adapted to maintain the position of the containers while allowing their movement, wherein the lower part of the device is smaller than the measurements of the container to be handled; and
(ii) performing the steps of exerting pressure by the elastic polymer cover upon the containers, and guiding the containers using the two side wings (17) so as to organize said containers in groups and form of palletization layers.

12. The Method of claim 11 wherein the device further performs the automatic exchange of tools.

13. The method of claim 11 wherein the device operates above a flat working area (2) allowing the entrance of the containers (C1) through a plurality of conveyors, wherein, when entering the flat working area, the containers are automatically identified via a computer software.

14. The method of claim 11 further comprising providing a robot (R1), and the steps further include using the robot to position the device (1) over the containers (C1) by controlled elastic pressure provided by the elastic polymer cover so as to avoid damage to the containers, and dragging it the containers lengthwise (L1), and crosswise (T1) and rotating (G1) the containers over the flat working area (2), and positioning the containers in an exact pre-determined position.

15. The method of claim 11 further comprising the step of monitoring the device by using software, so as to identify the need for changing the device when the elastic polymer is reaching the end of its working life.

16. The method of claim 15 further comprising the step of automatically changing the elastic polymer within seconds.

17. The method of claim 16 further comprising adjusting the attack pressure of the device and the tension of the compression spring system.

18. The method of claim 17 further wherein said attack pressure is calculated empirically, defining as a base the height of the container (C1) to be operated and advancement additional gradients at the height of the device, and performance evaluations are then made for each configuration.

19. The method of claim 15 wherein the device further comprises a metal head (6) attached to said metal frame, comprising a base set (7) and a flange (9), to engage the movement set or robot (R1), wherein, in the lower part of the base set (7) of the device (1), a set constituted by a lower metal plate (8) and covered with an elastic polymer (3) is assembled, having its design changed into a checkerboard, aiming to assure more efficient friction between the claw and the container (C1), after fixing the base set (7) to the upper plate (6) of the device (1), by means of a spring system (5), wherein said system, comprised by bolts (11) and pins, besides the essential constituents joining the lower metal plate (8) to the upper plate (6), considering that the connection as disclosed above is performed in four spots with holes (12), next to the vertices of the upper plate (10), coincident with fixing spots to the base set (7), being fixed to the upper plate (10) by innovative locking pins (13) for said flange (9).

20. The method of claim 15 wherein the device further comprise a connection performed by means of the lower sleeve (14) receiving the spring (5) and a guide pin (15), projecting from the sleeve (16) which is coupled to the upper plate (10) and, between the plate (7) and the lower sleeves (14), the side wings (17) are assembled, and thus the course of the system was increased, giving better flexibility to the system and the pin (15), which was relieved in its diameter, so to avoid locking during the operation, and consequently the protection ability for the robot against excessive torque was also improved, wherein the locking pins (13) receiving the set of locks constituted by the flange (9) used for engagement to the mouth of the robot (R1) are located on the middle of the upper plate (10); furthermore, innovative side wings (17) were incorporated to drag the container (C1), thus reducing the friction coefficient over the conveyor.
